(19) United States
(12) Patent Application Publication
(10) Pub. No.: US 2022/0144590 A1
(43) Pub. Date: May 12, 2022

(54) ROPELESS ELEVATOR PROPULSION SYSTEM

(71) Applicant: Otis Elevator Company, Farmington, CT (US)

(72) Inventors: Justin Billard, Amston, CT (US); Randy Roberts, Hebron, CT (US); Kiron Bhaskar, Farmington, CT (US); Kyle B. Martin, Avon, CT (US)

(21) Appl. No.: 17/092,233

(22) Filed: Nov. 7, 2020

(51) Int. Cl. B66B 9/02; B66B 11/00; B66B 11/04

(52) U.S. Cl. CPC B66B 9/02; B66B 11/043; B66B 11/005

(57) ABSTRACT

According to an embodiment, an elevator system including: a beam climber system configured to move an elevator car through an elevator shaft by climbing a first guide beam that extends vertically through the elevator shaft, the first guide beam including a first surface and a second surface opposite the first surface, the beam climber system including: a first wheel; a second wheel; a first traction belt wrapped around the first wheel and the second wheel, the first traction belt being in contact with the first surface; and a first electric motor configured to rotate the first wheel, wherein the first traction belt is configured to rotate when the first wheel rotates.

### BACKGROUND

The subject matter disclosed herein relates generally to the field of ropeless elevator systems, and specifically to a method and apparatus for propelling a ropeless elevator system.

Elevator cars are conventionally operated by ropes and counterweights, which typically only allow one elevator car in an elevator shaft at a single time. Ropeless elevator systems may allow for more than one elevator car in the elevator shaft at a single time.

### BRIEF SUMMARY

According to an embodiment, an elevator system is provided. The elevator system including: a beam climber system configured to move an elevator car through an elevator shaft by climbing a first guide beam that extends vertically through the elevator shaft, the first guide beam including a first surface and a second surface opposite the first surface, the beam climber system including: a first wheel; a second wheel; a first traction belt wrapped around the first wheel and the second wheel, the first traction belt being in contact with the first surface; and a first electric motor configured to rotate the first wheel, wherein the first traction belt is configured to rotate when the first wheel rotates.

In addition to one or more of the features described herein, or as an alternative, further embodiments may include that the first traction belt is magnetically attracted to the first guide beam.

In addition to one or more of the features described herein, or as an alternative, further embodiments may include that the first traction belt is configured to climb up or down the first guide beam when rotated.

In addition to one or more of the features described herein, or as an alternative, further embodiments may include that the beam climber system further includes: a third wheel in contact with the second surface.

In addition to one or more of the features described herein, or as an alternative, further embodiments may include that the third wheel is located opposite the first wheel.

In addition to one or more of the features described herein, or as an alternative, further embodiments may include that the first traction belt is composed of a flexible magnetic sheet.

In addition to one or more of the features described herein, or as an alternative, further embodiments may include that the first traction belt is composed of a backing belt and coated magnets.

In addition to one or more of the features described herein, or as an alternative, further embodiments may include that the first traction belt is magnetized.

In addition to one or more of the features described herein, or as an alternative, further embodiments may include a second guide beam that extends vertically through the elevator shaft, the second guide beam including a first surface of the second guide beam and a second surface of the second guide beam opposite the first surface of the second guide beam, wherein the beam climber system further includes: a third wheel; a fourth wheel; a second traction belt wrapped around the third wheel and the fourth wheel, the second traction belt being in contact with the first surface of the second guide beam and being magnetically attracted to the second guide beam; a second electric motor configured to rotate the third wheel, wherein the second traction belt is configured to rotate when the third wheel rotates.

In addition to one or more of the features described herein, or as an alternative, further embodiments may include that the second traction belt is configured to climb up or down the second guide beam when rotated.

According to another embodiment, an elevator system is provided. The elevator system including: a beam climber system configured to move an elevator car through an elevator shaft by climbing a first guide beam that extends vertically through the elevator shaft, the first guide beam including a first surface and a second surface opposite the first surface, the beam climber system including: a first wheel; a second wheel; a first motor configured to rotate the first wheel; a first traction belt wrapped around the first wheel, the second wheel, and the first motor, the first traction belt being in contact with the first surface, wherein the first traction belt, the first wheel, and the second wheel are configured to rotate when the first motor rotates.

In addition to one or more of the features described herein, or as an alternative, further embodiments may include that the first traction belt is configured to climb up or down the first guide beam when rotated.

In addition to one or more of the features described herein, or as an alternative, further embodiments may include that the first traction belt is a toothed timing belt.

In addition to one or more of the features described herein, or as an alternative, further embodiments may include that the first traction belt is a traditional flat belt.

In addition to one or more of the features described herein, or as an alternative, further embodiments may include that the beam climber system further includes a structural support frame, the structural support frame including a first vertical component, a second vertical component, and a horizontal component connecting the first vertical component and the second vertical component.

In addition to one or more of the features described herein, or as an alternative, further embodiments may include that the beam climber system further includes a first pivot arm, wherein the first wheel is operably attached to the first vertical component through the first pivot arm.

In addition to one or more of the features described herein, or as an alternative, further embodiments may include that the beam climber system further includes a second pivot arm, wherein the second wheel is operably attached to the first vertical component through the second pivot arm.

In addition to one or more of the features described herein, or as an alternative, further embodiments may include that the beam climber system further includes a third pivot arm, wherein the first wheel and the second wheel are operably connected to the third pivot arm.

In addition to one or more of the features described herein, or as an alternative, further embodiments may include that the beam climber system further includes a first spring extending between the first pivot arm to the horizontal component.

In addition to one or more of the features described herein, or as an alternative, further embodiments may include that the beam climber system further including a first biasing assembly operably attached to the third pivot arm, the first biasing assembly configured to press the first roller wheel against the first traction belt, which is pressed against the first surface of the first guide beam.

Technical effects of embodiments of the present disclosure include compressing a tread against a beam using magnetism or pressure for the elevator to climb through an elevator shaft.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system with a beam climber system, in accordance with an embodiment of the disclosure;

FIG. 2 illustrates a side view of the beam climber system of FIG. 1, in accordance with an embodiment of the disclosure;

FIG. 3 illustrates an enlarge view of a magnetic tread of FIG. 2, in accordance with an embodiment of the disclosure;

FIG. 4 illustrates an enlarge view of a magnetic tread of FIG. 2, in accordance with an embodiment of the disclosure;

FIG. 5 is a schematic illustration of an elevator system with a beam climber system, in accordance with an embodiment of the disclosure;

FIG. 6 illustrates a side view of the beam climber system of FIG. 5, in accordance with an embodiment of the disclosure;

FIG. 7 illustrates an enlarge view of a magnetic tread of FIG. 6, in accordance with an embodiment of the disclosure;

FIG. 8 illustrates an enlarge view of a magnetic tread of FIG. 6, in accordance with an embodiment of the disclosure; and

FIG. 9 is a schematic illustration of an elevator system with a beam climber system, in accordance with an embodiment of the disclosure.

### DETAILED DESCRIPTION

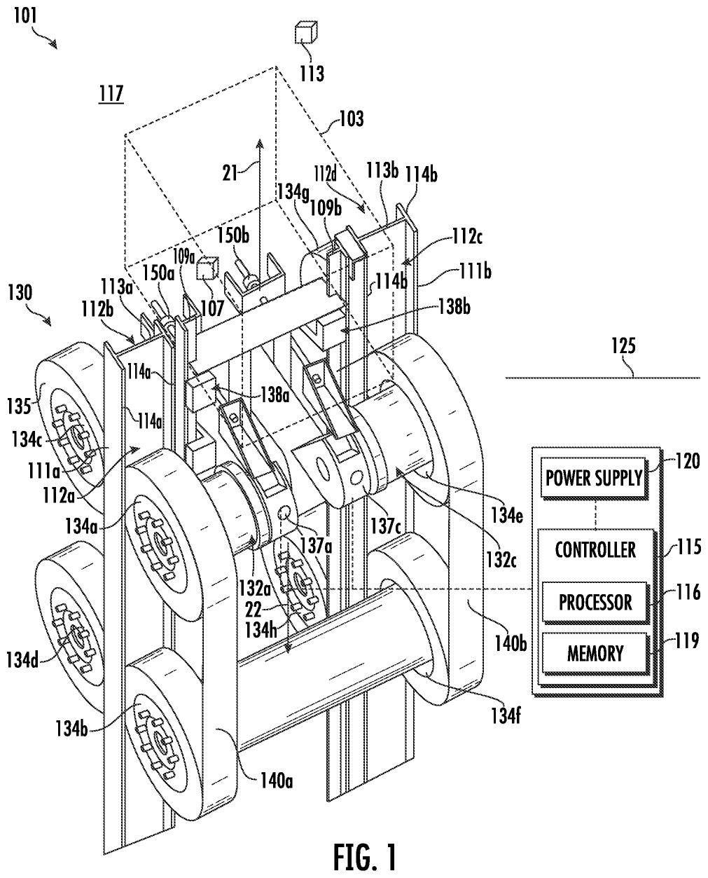

Referring now to FIGS. 1-4, FIG. 1 is a perspective view of an elevator system 101 including an elevator car 103, a beam climber system 130, a controller 115, and a power supply 120. Although illustrated in FIG. 1 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 1 as separate from the beam climber system 130, the embodiments described herein may be applicable to a power supply 120 included in the beam climber system 130 (i.e., moving through the elevator shaft 117 with the beam climber system 130) and may also be applicable to a power supply located off of the beam climber system 130 (i.e., remotely connected to the beam climber system 130 and stationary relative to the beam climber system 130).

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132c. The electric motors 132a, 132c are configured to move the beam climber system 130 within the elevator shaft 117 by rotating one or more wheels 134a, 134e, which rotate traction belts 140a, 140b that are pressed against a guide beam 111a, 111b. In an embodiment, the guide beams 111a, 111b are I-beams. It is understood that while an I-beam is illustrated, any beam or similar structure may be utilized with the embodiment described herein.

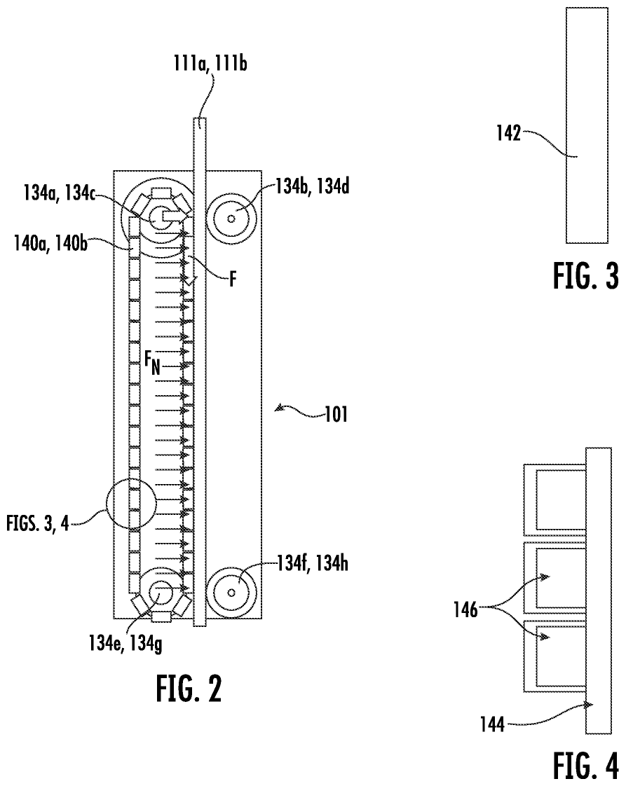

The traction belts 140a, 140b may be configured to magnetically attract to the guide beams 111a, 111b. The traction belts 140a, 140b may be magnetized and/or the guide beams 111a, 111b may be magnetized. Magnetic attraction between the guide beams 111a, 111b and the traction belts 140a, 140b driven by the electric motors 132a, 132c allows the beam climber system 130 to climb up 21 and down 22 the guide beams 111a, 111b. The magnetic attraction creates a large normal force F_{N} pushing the traction belt 140a, 140b against the guide beams 111a, 111b, as shown in FIG. 2. Then rotation of the motorized wheels 134a, 134c create a force F parallel to the guide beams 111a, 111b, which allows the traction belt 140a, 140b to climb up 21 or down 22 the guide beam 111a, 111b, as shown in FIG. 2. In an embodiment, the traction belt 140a, 140b may be composed of a flexible magnetic sheet 142 as illustrated in FIG. 3. In another embodiment, the traction belt 140a, 140b may be composed of a backing belt 144 and coated magnets 146 as illustrated in FIG. 4.

The guide beam extends vertically through the elevator shaft 117. It is understood that while two guide beams 111a, 111b are illustrated, the embodiments disclosed herein may be utilized with one or more guide beams. It is also understood that while two electric motors 132a, 132c are visible, the embodiments disclosed herein may be applicable to beam climber systems 130 having one or more electric motors. For example, the beam climber system 130 may have one electric motor for each wheel 134a, 134b, 134c, 134d, 134e, 134f, 134g, 134h. The electrical motors 132a, 132c may be permanent magnet electrical motors, asynchronous motor, or any electrical motor known to one of skill in the art.

The beam climber system 130 may include eight wheels 134a, 134b, 134c, 134d, 134e, 134f, 134g, 134h, which includes a first wheel 134a, a third wheel 134c, a fifth wheel 134e, a seventh wheel 134g, a second wheel 134b, a fourth wheel 134d, a sixth wheel 134f, and an eighth wheel 134h. As illustrated in FIG. 1, the first traction belt 140a may extend between and wrap around the first wheel 134a and the second wheel 134b. The first traction belt 140a rotates around the first wheel 134a and the second wheel 134b. The rotation of the first wheel 134a causes the first traction belt 140a to rotate, which causes the second wheel 134b to rotate. As illustrated in FIG. 1, the second traction belt 140b may extend between and wrap around the fifth wheel 134e and the sixth wheel 134f. The second traction belt 140b rotates around the fifth wheel 134e and the sixth wheel 134f The rotation of the fifth wheel 134e causes the second traction belt 140b to rotate, which causes the sixth wheel 134f to rotate.

The third wheel 134c, seventh wheel 134g, fourth wheel 134d, and eighth wheel 134h may act as idler wheels and be free to rotate with the movement of the other wheels 134a, 134b, 134e, 134f.

The third wheel 134c may be located opposite the first wheel 134, the fourth wheel 134d may be located opposite the second wheel 134b, the seventh wheel 134g may be located opposite the fifth wheel 134e, and the eighth wheel 134h may be located opposite the sixth wheel 134f.

The first guide beam 111a includes a web portion 113a and two flange portions 114a. The web portion 113a of the first guide beam 111a includes a first surface 112a and a second surface 112b opposite the first surface 112a. The first wheel 134a and the second wheel 134b are in contact with the first surface 112a through the first traction belt 140a and a third wheel 134c and the fourth wheel 134d may each be in contact with the second surface 112b through tires 135. The first wheel 134a and the second wheel 134b are compressed against the first surface 112a of the first guide beam 111a by a first compression mechanism 150a and the third wheel 134c and the fourth wheel 134d are compressed against the second surface 112b of the first guide beam 111a by the first compression mechanism 150a. The first compression mechanism 150a compresses the first wheel 134a and the third wheel 134c together to clamp onto the web portion 113a of the first guide beam 111a. The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 101 to control compression of the first wheel 134a and the third wheel 134c on the first guide beam 111a. The third wheel 134c and the fourth wheel 134d may each include a tire 135 to increase traction with the first guide beam 111a.

The first surface 112a and the second surface 112b extend vertically through the shaft 117, thus creating a track for the first traction belt 140a, the third wheel 134c, and the fourth wheel 134d to ride on. The flange portions 114a may work as guardrails to help guide the first traction belt 140a, the third wheel 134c, and the fourth wheel 134d along this track and thus help prevent the first traction belt 140a, the third wheel 134c, and the fourth wheel 134d from running off track.

The first electric motor 132a is configured to rotate the first wheel 134a, which rotates the first traction belt 140a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109a proximate the elevator car 103.

The second guide beam 111b includes a web portion 113b and two flange portions 114b. The web portion 113b of the second guide beam 111b includes a first surface 112c and a second surface 112d opposite the first surface 112c. A fifth wheel 134e and a sixth wheel 134f are in contact with the first surface 112c through the second traction belt 140b and a seventh wheel 134g and eighth wheel 134h may each be in contact with the second surface 112d through tires 135. A fifth wheel 134e is compressed against the first surface 112c of the second guide beam 111b by a second compression mechanism 150b and a seventh wheel 134g is compressed against the second surface 112d of the second guide beam 111b by the second compression mechanism 150b. The second compression mechanism 150b compresses the fifth wheel 134e and the seventh wheel 134g together to clamp onto the web portion 113b of the second guide beam 111b. The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 101 to control compression of the fifth wheel 134e and the seventh wheel 134g on the second guide beam 111b. The seventh wheel 134g and the eighth wheel 134h may each include a tire 135 to increase traction with the second guide beam 111b.

The first surface 112c and the second surface 112d extend vertically through the shaft 117, thus creating a track for the second traction belt 140b, the seventh wheel 134g, and the eighth wheel 140h to ride on. The flange portions 114b may work as guardrails to help guide the second traction belt 140b, the seventh wheel 134g, and the eighth wheel 140h along this track and thus help prevent the second traction belt 140b, the seventh wheel 134g, and the eighth wheel 140h from running off track.

The second electric motor 132c is configured to rotate the fifth wheel 134e, which rotates the second traction belt 140b to climb up 21 or down 22 the second guide beam 111b. The second electric motor 132c may also include a third motor brake 137c to slow and stop rotation of the third motor 132c. The third motor brake 137c may be mechanically connected to the third motor 132c. The third motor brake 137c may be a clutch system, a disc brake system, drum brake system, a brake on a rotor of the second electric motor 132c, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 103.

The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130. In embodiment, the controller 115 controls on-board motion control of the beam climber system 130 (e.g., a supervisory function above the individual motor controllers).

The power supply 120 for the elevator system 101 may be any power supply, including a power grid and/or battery power which, in combination with other components, is supplied to the beam climber system 130. In one embodiment, power supply 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

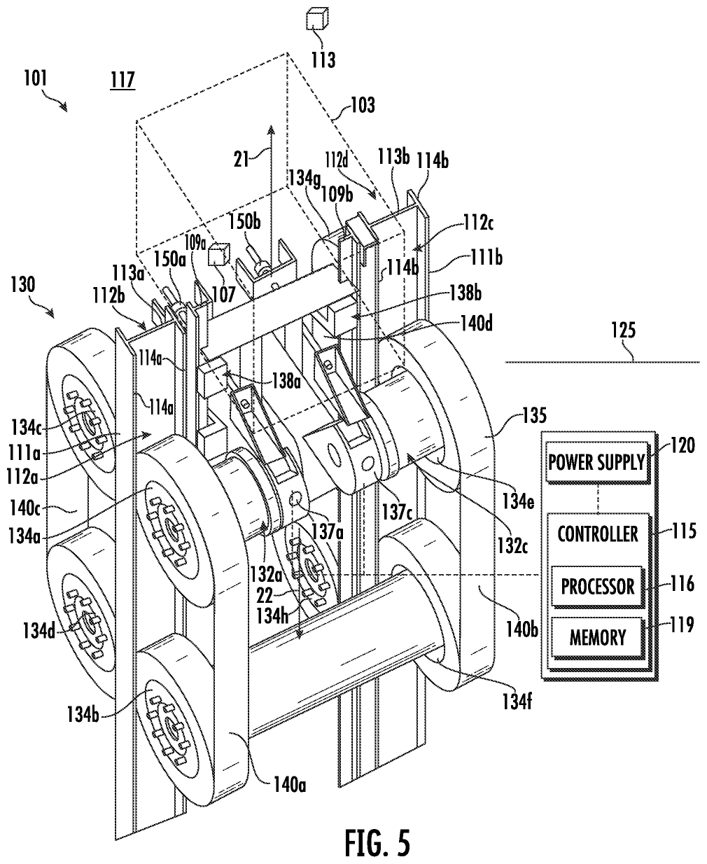

Referring now to FIGS. 5-8, FIG. 5 is a perspective view of an elevator system 101 including an elevator car 103, a beam climber system 130, a controller 115, and a power supply 120. Although illustrated in FIG. 5 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 5 as separate from the beam climber system 130, the embodiments described herein may be applicable to a power supply 120 included in the beam climber system 130 (i.e., moving through the elevator shaft 117 with the beam climber system 130) and may also be applicable to a power supply located off of the beam climber system 130 (i.e., remotely connected to the beam climber system 130 and stationary relative to the beam climber system 130).

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132c. The electric motors 132a, 132c are configured to move the beam climber system 130 within the elevator shaft 117 by rotating one or more wheels 134a, 134e, which rotate traction belts 140a, 140b that are pressed against a guide beam 111a, 111b. In an embodiment, the guide beams 111a, 111b are I-beams. It is understood that while an I-beam is illustrated, any beam or similar structure may be utilized with the embodiment described herein. The beam climber system 130 may include four tractions belts 140a, 140b, 140c, 140d.

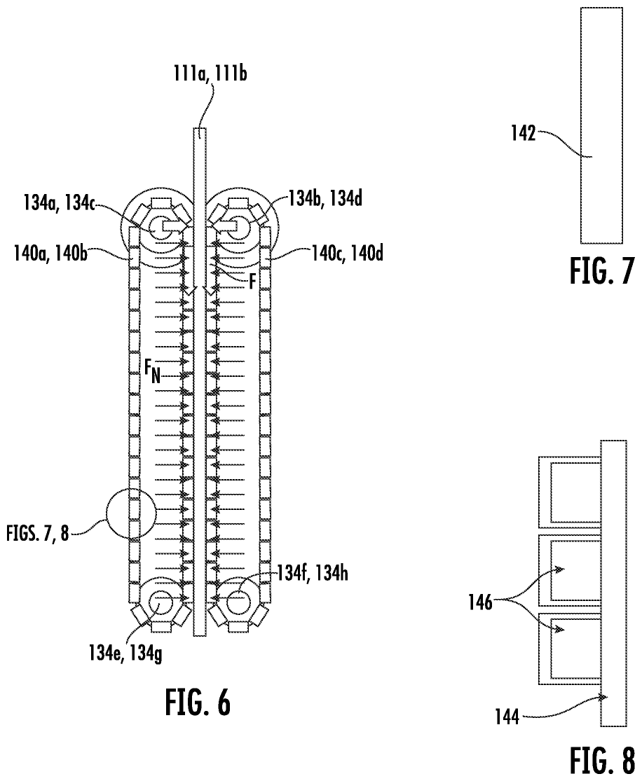

The traction belts 140a, 140b, 140c, 140d may be configured to magnetically attract to the guide beams 111a, 111b. The traction belts 140a, 140b, 140c, 140d may be magnetized and/or the guide beams 111a, 111b may be magnetized. Magnetic attraction between the guide beams 111a, 111b and the traction belts 140a, 140b, 140c, 140d driven by the electric motors 132a, 132c allows the beam climber system 130 to climb up 21 and down 22 the guide beams 111a, 111b. The magnetic attraction creates a large normal force F_{N} pushing the traction belt 140a, 140b, 140c, 140d against the guide beams 111a, 111b, as shown in FIG. 7. Then rotation of the motorized wheels 134a, 134c create a force F parallel to the guide beams 111a, 111b, which allows the traction belt 140a, 140b, 140c, 140d to climb up 21 or down 22 the guide beam 111a, 111b, as shown in FIG. 6. In an embodiment, the traction belt 140a, 140b, 140c, 140d may be composed of a flexible magnetic sheet 142 as illustrated in FIG. 7. In another embodiment, the traction belt 140a, 140b, 140c, 140d may be composed of a backing belt 144 and coated magnets 146 as illustrated in FIG. 8.

The guide beam extends vertically through the elevator shaft 117. It is understood that while two guide beams 111a, 111b are illustrated, the embodiments disclosed herein may be utilized with one or more guide beams. It is also understood that while two electric motors 132a, 132c are visible, the embodiments disclosed herein may be applicable to beam climber systems 130 having one or more electric motors. For example, the beam climber system 130 may have one electric motor for each wheel 134a, 134b, 134c, 134d, 134e, 134f, 134g, 134h. The electrical motors 132a, 132c may be permanent magnet electrical motors, asynchronous motor, or any electrical motor known to one of skill in the art.

The beam climber system 130 may include eight wheels 134a, 134b, 134c, 134d, 134e, 134f, 134g, 134h, which includes a first wheel 134a, a third wheel 134c, a fifth wheel 134e, a seventh wheel 134g, a second wheel 134b, a fourth wheel 134d, a sixth wheel 134f, and an eighth wheel 134h. As illustrated in FIG. 5, the first traction belt 140a may extend between and wrap around the first wheel 134a and the second wheel 134b. The first traction belt 140a rotates around the first wheel 134a and the second wheel 134b. The rotation of the first wheel 134a causes the first traction belt 140a to rotate, which causes the second wheel 134b to rotate. As illustrated in FIG. 5, the second traction belt 140b may extend between and wrap around the fifth wheel 134e and the sixth wheel 134f. The second traction belt 140b rotates around the fifth wheel 134e and the sixth wheel 134f The rotation of the fifth wheel 134e causes the second traction belt 140b to rotate, which causes the sixth wheel 134f to rotate.

As illustrated in FIG. 5, the third traction belt 140c may extend between and wrap around the third wheel 134c and the fourth wheel 134d. The third traction belt 140c rotates around the third wheel 134c and the fourth wheel 134d. As illustrated in FIG. 5, the fourth traction belt 140d may extend between and wrap around the seventh wheel 134g and the eighth wheel 134h. The fourth traction belt 140d rotates around the seventh wheel 134g and the eighth wheel 134h.

In the embodiment illustrated in FIG. 5, the third wheel 134c, seventh wheel 134g, fourth wheel 134d, and eighth wheel 134h may act as idler wheels and be free to rotate with the movement of the other wheels 134a, 134b, 134e, 134f.

The third wheel 134c may be located opposite the first wheel 134, the fourth wheel 134d may be located opposite the second wheel 134b, the seventh wheel 134g may be located opposite the fifth wheel 134e, and the eighth wheel 134h may be located opposite the sixth wheel 134f.

The first guide beam 111a includes a web portion 113a and two flange portions 114a. The web portion 113a of the first guide beam 111a includes a first surface 112a and a second surface 112b opposite the first surface 112a. The first wheel 134a and the second wheel 134b are in contact with the first surface 112a through the first traction belt 140a and a third wheel 134c and the fourth wheel 134d may each be in contact with the second surface 112b through the third traction belt 140c, in accordance with the embodiment illustrated in FIG. 5. The first wheel 134a and the second wheel 134b are compressed against the first surface 112a of the first guide beam 111a by a first compression mechanism 150a and the third wheel 134c and the fourth wheel 134d are compressed against the second surface 112b of the first guide beam 111a by the first compression mechanism 150a. The first compression mechanism 150a compresses the first wheel 134a and the third wheel 134c together to clamp onto the web portion 113a of the first guide beam 111a. The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 101 to control compression of the first wheel 134a and the third wheel 134c on the first guide beam 111a.

The first surface 112a and the second surface 112b extend vertically through the shaft 117, thus creating a track for the first traction belt 140a and the third traction belt 140c to ride on. The flange portions 114a may work as guardrails to help guide the first traction belt 140a and the third traction belt 140c along this track and thus help prevent the first traction belt 140a and the third traction belt 140c from running off track.

The first electric motor 132a is configured to rotate the first wheel 134a, which rotates the first traction belt 140a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109a proximate the elevator car 103.

The second guide beam 111b includes a web portion 113b and two flange portions 114b. The web portion 113b of the second guide beam 111b includes a first surface 112c and a second surface 112d opposite the first surface 112c. A fifth wheel 134e and a sixth wheel 134f are in contact with the first surface 112c through the second traction belt 140b and a seventh wheel 134g and eighth wheel 134h may each be in contact with the second surface 112d the fourth traction belt 140d. A fifth wheel 134e is compressed against the first surface 112c of the second guide beam 111b by a second compression mechanism 150b and a seventh wheel 134g is compressed against the second surface 112d of the second guide beam 111b by the second compression mechanism 150b. The second compression mechanism 150b compresses the fifth wheel 134e and the seventh wheel 134g together to clamp onto the web portion 113b of the second guide beam 111b. The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 101 to control compression of the fifth wheel 134e and the seventh wheel 134g on the second guide beam 111b.

The first surface 112c and the second surface 112d extend vertically through the shaft 117, thus creating a track for the second traction belt 140b and the fourth traction belt 140d to ride on. The flange portions 114b may work as guardrails to help guide the second traction belt 140b and the fourth traction belt 140d along this track and thus help prevent the second traction belt 140b and the fourth traction belt 140d from running off track.

The second electric motor 132c is configured to rotate the fifth wheel 134e, which rotates the second traction belt 140b to climb up 21 or down 22 the second guide beam 111b. The second electric motor 132c may also include a third motor brake 137c to slow and stop rotation of the third motor 132c. The third motor brake 137c may be mechanically connected to the third motor 132c. The third motor brake 137c may be a clutch system, a disc brake system, drum brake system, a brake on a rotor of the second electric motor 132c, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 103.

The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130. In embodiment, the controller 115 controls on-board motion control of the beam climber system 130 (e.g., a supervisory function above the individual motor controllers).

The power supply 120 for the elevator system 101 may be any power supply, including a power grid and/or battery power which, in combination with other components, is supplied to the beam climber system 130. In one embodiment, power supply 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

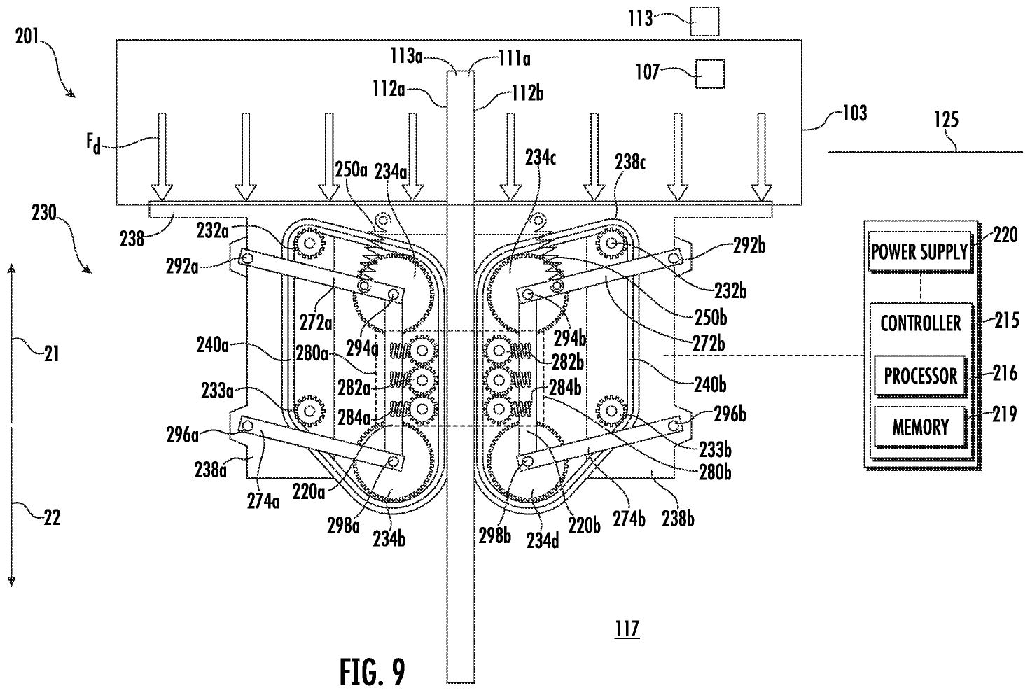

FIG. 9 is a side view of an elevator system 201 including an elevator car 103, a beam climber system 230, a controller 215, and a power supply 220. Although illustrated in FIG. 9 as separate from the beam climber system 230, the embodiments described herein may be applicable to a controller 215 included in the beam climber system 230 (i.e., moving through an elevator shaft 117 with the beam climber system 230) and may also be applicable to a controller located off of the beam climber system 230 (i.e., remotely connected to the beam climber system 230 and stationary relative to the beam climber system 230). Although illustrated in FIG. 9 as separate from the beam climber system 230, the embodiments described herein may be applicable to a power supply 220 included in the beam climber system 230 (i.e., moving through the elevator shaft 117 with the beam climber system 230) and may also be applicable to a power supply located off of the beam climber system 230 (i.e., remotely connected to the beam climber system 230 and stationary relative to the beam climber system 230).

The beam climber system 230 is configured to move the elevator car 103 within the elevator shaft 117. The beam climber system 230 includes one or more motors 232a, 232c. The motors 232a, 232b, 233a, 233b are configured to move the beam climber system 230 within the elevator shaft 117 by rotating one or more wheels 234a, 234b, which rotate traction belts 240a, 240b that are pressed against a guide beam 111a, 111b. In an embodiment, the guide beams 111a, 111b are I-beams. It is understood that while an I-beam is illustrated, any beam or similar structure may be utilized with the embodiment described herein. The traction belts 240a, 240b may be a toothed timing belt or a traditional flat belt, such as, for example, a coated steel belt. The coated steel belt may achieve traction via contact pressure and a coefficient of friction.

The guide beam extends vertically through the elevator shaft 117. It is understood that while one guide beams 111a is illustrated, the embodiments disclosed herein may be utilized with one or more guide beams. It is also understood that while four motors 232a, 233a, 232b, 233b are illustrated visible, the embodiments disclosed herein may be applicable to beam climber systems 230 having two or more motors. The motors 232a, 233a, 232b, 233b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 103).

The beam climber system 320 may include four wheels 234a, 234b, 234c, 234d, which includes a first wheel 234a, a second wheel 234b, a third wheel 234c, and a fourth wheel 234d. As illustrated in FIG. 9, the first traction belt 240a may extend around the first wheel 234a, the second wheel 234b, the first motor 232a, and the second motor 233a. The first traction belt 240a rotates around the first wheel 234a, the second wheel 234b, the first motor 232a, and the second motor 233a. The rotation of the first motor 232a and/or the second motor 233a causes the first traction belt 240a to rotate, which then rotates the first wheel 234a and the second wheel 234b. In an embodiment, the second motor 233a may be replaced by an idler and be free to rotate with the movement of the first wheel 234a.

As illustrated in FIG. 9, the second traction belt 240b may extend around the third wheel 234c, the fourth wheel 234d, the third motor 232b, and the fourth motor 233b. The second traction belt 240b rotates around the third wheel 234c, the fourth wheel 234d, the third motor 232b, and the fourth motor 233b. The rotation of the third motor 232b and/or the fourth motor 232c causes the second traction belt 240b to rotate, which then rotates the third wheel 234c and the fourth wheel 234d. In an embodiment, the fourth motor 233b may be replaced by an idler and be free to rotate with the movement of the third wheel 234c.

The first guide beam 111a includes a web portion 113a and two flange portions (not shown for simplicity). The web portion 113a of the first guide beam 111a includes a first surface 112a and a second surface 112b opposite the first surface 112a. The first wheel 134a and the second wheel 134b are in contact with the first surface 112a through the first traction belt 240a. The third wheel 234c and the fourth wheel 134d are in contact with the second surface 112b through the second traction belt 240b.

The beam climber system 230 a structural support frame 238. The structural support frame 238 includes a first vertical component 238a, a second vertical component 238b, and a horizontal component 238c connecting the first vertical 238a and second vertical component 238b. The first vertical component 238a and the second vertical component 238b may be oriented about parallel to the first guide beam 111a. The horizontal component 238c may be oriented about perpendicular to the first guide beam 111a.

The first wheel 234a and the second wheel 234b are located between the first vertical component 238a and the first guide beam 111a. The third wheel 234c and the fourth wheel 234d are located between the second vertical component 238b and the first guide beam 111a.

The first wheel 234a and the second wheel 234b are compressed against the first surface 112a of the first guide beam 111a by a downward force F_{d} when going downward 22 and when going upward 21. The downward force F_{d} is generated by the weight of the elevator car 103 and the beam climber system 230. The first spring 250a extends from a first pivot arm 272a to the horizontal component 238c. The first spring 250a is configured to maintain contact in an event of a rapid deceleration while ascending.

The first wheel 234a is operably attached to the first vertical component 238a of a structural support frame 238 of the beam climber system 230 through the first pivot arm 272a. The first pivot arm 272a is operably attached to the first vertical component 238a of the structural support frame 238 at a first pivot point 292a. Pivot points may be defined herein as rotatable connection points, pivot axles, or hinge points between two or more components. The first pivot arm 272a may rotate or pivot around the first pivot point 292a. The first pivot arm 272a is operably attached to the first wheel 234a at a second pivot point 294a. The first pivot arm 272a may rotate or pivot around the second pivot point 294a. The first wheel 234a may rotate around the second pivot point 294a.

The second wheel 234b is operably attached to the first vertical component 238a of the structural support frame 238 of the beam climber system 230 through a second pivot arm 274a. The second pivot arm 274a is operably attached to the first vertical component 238a at a third pivot point 296a. The second pivot arm 274a may rotate or pivot around the third pivot point 296a. The second pivot arm 274a is operably attached to the second wheel 234b at a fourth pivot point 298a. The second pivot arm 274a may rotate or pivot around the fourth pivot point 298a. The second wheel 234b may rotate around the fourth pivot point 298a.

The first wheel 234a and the second wheel 234b may be operably connected to a third pivot arm 220a. The third pivot arm 220a is operably connected to the first wheel 234a at the second pivot point 294a. The third pivot arm 220a may rotate or pivot around the second pivot point 294a. The third pivot arm 220a is operably connected to the second wheel 234b at the fourth pivot point 298a. The third pivot arm 220a may rotate or pivot around the fourth pivot point 298a.

The beam climber system 230 may also include a first biasing assembly 280a to further compress the first traction belt 240a. The first biasing assembly 280a may be operably attached to the third pivot arm 220a. The first biasing assembly 280a may include one or more first roller wheels 282a (i.e., sprocket) and each of the one or more first roller wheels 282a may be operably attached to the third pivot arm 220a through a first biasing mechanism 284a. The first biasing mechanism 284a is configured to press the first roller wheel 282a against the first traction belt 240a, which is pressed against the first surface 112a of the first guide beam 111a. The first biasing mechanism 284a may be a spring. Alternatively, the first biasing mechanism 284a and the first roller wheels 282a may be replaced by a low friction material (e.g., sliding guide) that pushes the first traction belt 240a into the beam. The third wheel 234c and the fourth wheel 234d are compressed against the second surface 112b of the first guide beam 111a by the downward force F_{d} when going downward 22 and when going upward 21. The downward force F_{d} is generated by the weight of the elevator car 103 and the beam climber system 230. The second spring 250b extends from a fourth pivot arm 272b to the horizontal component 238c. The second spring 250b is configured to maintain contact in an event of a rapid deceleration while ascending.

The third wheel 234c is operably attached to the second vertical component 238b of the structural support frame 238 of the beam climber system 230 through a fourth pivot arm 272b. The fourth pivot arm 272b is operably attached to the second vertical component 238b at a fifth pivot point 292b. The fourth pivot arm 272b may rotate or pivot around the fifth pivot point 292b. The fourth pivot arm 272b is operably attached to the third wheel 234c at a sixth pivot point 294b. The fourth pivot arm 272b may rotate or pivot around the sixth pivot point 294b. The third wheel 234c may rotate around the sixth pivot point 294b.

The fourth wheel 234d is operably attached to the second vertical component 238b of the structural support frame 238 of the beam climber system 230 through a fifth pivot arm 274b. The fifth pivot arm 274b is operably attached to the second vertical component 238b at a seventh pivot point 296b. The fifth pivot arm 274b may rotate or pivot around the seventh pivot point 296b. The fifth pivot arm 274b is operably attached to the fourth wheel 234d at an eighth pivot point 298b. The fifth pivot arm 274b may rotate or pivot around the eighth pivot point 298b. The fourth wheel 234d may rotate around the eighth pivot point 298b.

The third wheel 234c and the fourth wheel 234d may be operably connected to a sixth pivot arm 220b. The sixth pivot arm 220b is operably connected to the third wheel 234c at the sixth pivot point 294b. The sixth pivot arm 220b may rotate or pivot around the sixth pivot point 294b. The sixth pivot arm 220b is operably connected to the fourth wheel 234d at the eighth pivot point 298b. The sixth pivot arm 220b may rotate or pivot around the eighth pivot point 298b.

The beam climber system 230 may also include a second biasing assembly 280b to further compress the first traction belt 240a. The second biasing assembly 280b may be operably attached to the sixth pivot arm 220b. The second biasing assembly 280b may include one or more second roller wheels 282b and each of the one or more second roller wheels 282b may be operably attached to the sixth pivot arm 220b through a second biasing mechanism 284b. The second biasing mechanism 284b is configured to press the second roller wheel 282b against the second traction belt 240b, which is pressed against the second surface 112b of the first guide beam 111a. The second biasing mechanism 284b may be a spring. Alternatively, the second biasing mechanism 284b and the second roller wheels 282b may be replaced by a low friction material (e.g., sliding guide) that pushes the first traction belt 240a into the beam.

The first surface 112a extends vertically through the shaft 117, thus creating a track for the first traction belt 240a to ride on. The second surface 112b extends vertically through the shaft 117, thus creating a track for the second traction belt 240b to ride on.

The first motor 232a, the second motor 233a, the third motor 232b, and the fourth motor 233b may be electrical motors may be permanent magnet electrical motors, asynchronous motor, or any electrical motor known to one of skill in the art.

The first motor 232a and/or the second motor 233a are configured to rotate the first the first traction belt 240a to climb up 21 or down 22 the first guide beam 111a. The first wheel 234a and the second wheel 234b also rotate when the first traction belt 240a rotates. The first motor 232a and the second motor 233a may also include a motor brake (not shown for simplicity) to slow and stop rotation of the first traction belt 240a. The motor brake of the first motor 232a may be mechanically connected to the first motor 232a and the motor brake of the second motor 233a may be mechanically connected to the second motor 233a. The motor brake may be a clutch system, a disc brake system, a drum brake system, a brake on a rotor of the first electric motor, an electronic braking, an Eddy current brakes, a Magnetorheological fluid brake or any other known braking system.

The third motor 232b and/or the fourth motor 233b are configured to rotate the first the second traction belt 240b to climb up 21 or down 22 the first guide beam 111a. The third wheel 234c and the fourth wheel 234d also rotate when the second traction belt 240b rotates. The third motor 232b and the fourth motor 233b may also include a motor brake (not shown for simplicity) to slow and stop rotation of the second traction belt 240b. The motor brake of the third motor 232b may be mechanically connected to the third motor 232b and the motor brake of the fourth motor 233b may be mechanically connected to the fourth motor 233b. The motor brake may be a clutch system, a disc brake system, a drum brake system, a brake on a rotor of the first electric motor, an electronic braking, an Eddy current brakes, a Magnetorheological fluid brake or any other known braking system.

The elevator system 201 may also include a position reference system 113. The position reference system 113 may be mounted on a fixed part at the top of the elevator shaft 117, such as on a support, the first guide beam 111a, or any guide rail, and may be configured to provide position signals related to a position of the elevator car 103 within the elevator shaft 117. In other embodiments, the position reference system 113 may be directly mounted to a moving component of the elevator system 201 (e.g., the elevator car 103 or the beam climber system 230), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 215 may be an electronic controller including a processor 216 and an associated memory 219 comprising computer-executable instructions that, when executed by the processor 216, cause the processor 216 to perform various operations. The processor 216 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 219 may be but is not limited to a random access memory (RAM), read only memory (ROM), or other electronic, optical, magnetic or any other computer readable medium.

The controller 215 is configured to control the operation of the elevator car 103 and the beam climber system 230. For example, the controller 215 may provide drive signals to the beam climber system 230 to control the acceleration, deceleration, leveling, stopping, etc. of the elevator car 103.

The controller 215 may also be configured to receive position signals from the position reference system 113 or any other desired position reference device.

When moving up 21 or down 22 within the elevator shaft 117, the elevator car 103 may stop at one or more landings 125 as controlled by the controller 215. In one embodiment, the controller 215 may be located remotely or in the cloud. In another embodiment, the controller 215 may be located on the beam climber system 230. In embodiment, the controller 215 controls on-board motion control of the beam climber system 230 (e.g., a supervisory function above the individual motor controllers).

The power supply 220 for the elevator system 201 may be any power supply, including a power grid and/or battery power which, in combination with other components, is supplied to the beam climber system 230. In one embodiment, power supply 220 may be located on the beam climber system 230. In an embodiment, the power supply 220 is a battery that is included in the beam climber system 230.

The elevator system 201 may also include an accelerometer 107 attached to the elevator car 103 or the beam climber system 230. The accelerometer 107 is configured to detect an acceleration and/or a speed of the elevator car 103 and the beam climber system 230.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the

What is claimed is:

1. An elevator system, the elevator system comprising:
a beam climber system configured to move an elevator car through an elevator shaft by climbing a first guide beam that extends vertically through the elevator shaft, the first guide beam comprising a first surface and a second surface opposite the first surface, the beam climber system comprising:
a first wheel;
a second wheel;
a first traction belt wrapped around the first wheel and the second wheel, the first traction belt being in contact with the first surface; and
a first electric motor configured to rotate the first wheel, wherein the first traction belt is configured to rotate when the first wheel rotates.

2. The elevator system of claim 1, wherein the first traction belt is magnetically attracted to the first guide beam.

3. The elevator system of claim 1, wherein the first traction belt is configured to climb up or down the first guide beam when rotated.

4. The elevator system of claim 1, wherein the beam climber system further comprises:
a third wheel in contact with the second surface.

5. The elevator system of claim 3, wherein the third wheel is located opposite the first wheel.

6. The elevator system of claim 2, wherein the first traction belt is composed of a flexible magnetic sheet.

7. The elevator system of claim 2, wherein the first traction belt is composed of a backing belt and coated magnets.

8. The elevator system of claim 2, wherein the first traction belt is magnetized.

9. The elevator system of claim 1, further comprising:
a second guide beam that extends vertically through the elevator shaft, the second guide beam comprising a first surface of the second guide beam and a second surface of the second guide beam opposite the first surface of the second guide beam,
wherein the beam climber system further comprises:
a third wheel;
a fourth wheel;
a second traction belt wrapped around the third wheel and the fourth wheel, the second traction belt being in contact with the first surface of the second guide beam and being magnetically attracted to the second guide beam;
a second electric motor configured to rotate the third wheel, wherein the second traction belt is configured to rotate when the third wheel rotates.

10. The elevator system of claim 9, wherein the second traction belt is configured to climb up or down the second guide beam when rotated.

11. An elevator system, the elevator system comprising:
a beam climber system configured to move an elevator car through an elevator shaft by climbing a first guide beam that extends vertically through the elevator shaft, the first guide beam comprising a first surface and a second surface opposite the first surface, the beam climber system comprising:
a first wheel;
a second wheel;
a first motor configured to rotate the first wheel;
a first traction belt wrapped around the first wheel, the second wheel, and the first motor, the first traction belt being in contact with the first surface,
wherein the first traction belt, the first wheel, and the second wheel are configured to rotate when the first motor rotates.

12. The elevator system of claim 11, wherein the first traction belt is configured to climb up or down the first guide beam when rotated.

13. The elevator system of claim 11, wherein the first traction belt is a toothed timing belt.

14. The elevator system of claim 11, wherein the first traction belt is a traditional flat belt.

15. The elevator system of claim 11, wherein the beam climber system further comprises a structural support frame, the structural support frame comprising a first vertical component, a second vertical component, and a horizontal component connecting the first vertical component and the second vertical component.

16. The elevator system of claim 15, wherein the beam climber system further comprises a first pivot arm, wherein the first wheel is operably attached to the first vertical component through the first pivot arm.

17. The elevator system of claim 16, wherein the beam climber system further comprises a second pivot arm, wherein the second wheel is operably attached to the first vertical component through the second pivot arm.

18. The elevator system of claim 17, wherein the beam climber system further comprises a third pivot arm, wherein the first wheel and the second wheel are operably connected to the third pivot arm.

19. The elevator system of claim 16, wherein the beam climber system further comprises a first spring extending between the first pivot arm to the horizontal component.

20. The elevator system of claim 18, wherein the beam climber system further comprising a first biasing assembly operably attached to the third pivot arm, the first biasing assembly configured to press the first roller wheel against the first traction belt, which is pressed against the first surface of the first guide beam.
